(19) United States
(12) Patent Application Publication
(10) Pub. No.: US 2012/0305722 A1
(43) Pub. Date: Dec. 6, 2012

(54) Support Straps For Displaying A Sports Board

(76) Inventor: Susan Krosky, Kersey, CO (US)

(21) Appl. No.: 13/485,351

(22) Filed: May 31, 2012

Related U.S. Application Data
(60) Provisional application No. 61/491,565, filed on May 31, 2011.

(51) Int. Cl. F16M 13/02; F16B 45/00; B23P 11/00

(52) U.S. Cl. 248/224.8; 29/428; 248/220.21

(57) ABSTRACT

A support strap is provided for suspending a sports board from a support structure. The support strap includes a strap having a first end and a second end. A first member is provided on the first end of the strap for removably connecting the first end of the strap to a support structure. A second member is provided on the second end of the strap for removably connecting the second end of the strap to the support structure. A third member is carried between the first and second ends of the strap for suspending a separate article from the strap. A portion of the strap is positioned between the sports board and the third member such that the sports board does not contact the third member when the sports board is suspended by the support strap.

### CROSS-REFERENCE TO RELATED APPLICATIONS

This application claims the benefit of U.S. Provisional Application No. 61/491,565 filed May 31, 2011, the disclosure of which is incorporated herein by reference.

### BACKGROUND OF THE INVENTION

This invention relates in general to support straps, such as can be used to suspend an article from a support structure for storage or display of the article. In particular, this invention relates to a plurality of support straps for suspending a sports board in a generally horizontal position from a support structure.

Sports boards and other types of sporting equipment are commonly used in a wide-variety of sports and recreational activities. Some of the more common types of sports boards include snowboards, snow and water skis, surfboards, wakeboards, skateboards, and the like. When a sports board is not in use, it is generally desirable to store the board in a convenient location. As such, a variety of support devices have been developed to accomplish this purpose. However, known support devices can be rather complex and typically require additional support structures such as a stand, a rack, shelving, or the like. It is also known to use support straps that are positioned near opposite ends of a sports board to suspend the board in a horizontal position from a ceiling or wall. Each support strap defines a closed loop that is slid over an end of the sports board. The loop is then secured by a tether having a single fastener to a mounting member that is provided on the ceiling or wall. However, this configuration can make it relatively difficult to install and subsequently remove the board from the ceiling or wall.

It is also well known for sports boards to include various color combinations, graphic designs, artwork, and other types of aesthetic features to enhance the overall appearance of the board. Thus, it would be desirable to display a sports board in such a manner that shows the various aesthetic features without risking damage to the board caused by the support device or use thereof. As such, it is an object of this invention to provide a plurality of support straps each having separable ends that can be looped around a sports board and easily secured to a support structure for suspending the board in a generally horizontal position.

### SUMMARY OF THE INVENTION

This invention relates to a support strap for use in suspending a sports board from a support structure in a generally horizontal position. The support strap includes a strap having a first end and a second end. A first member is provided on the first end of the strap for removably connecting the first end of the strap to a support structure. A second member is provided on the second end of the strap for removably connecting the second end of the strap to the support structure. A third member is carried between the first and second ends of the strap for suspending a separate article from the strap. A portion of the strap is positioned between the sports board and the third member such that the sports board does not contact the third member when the sports board is suspended by the support strap.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a sports board being supported relative to a support structure by a pair of support straps, in accordance with this invention.

FIG. 2 is a front elevational view of a single support strap shown in FIG. 1.

FIG. 3 is a side elevational view of the single support strap shown in FIG. 1.

### DETAILED DESCRIPTION OF THE PREFERRED EMBODIMENT

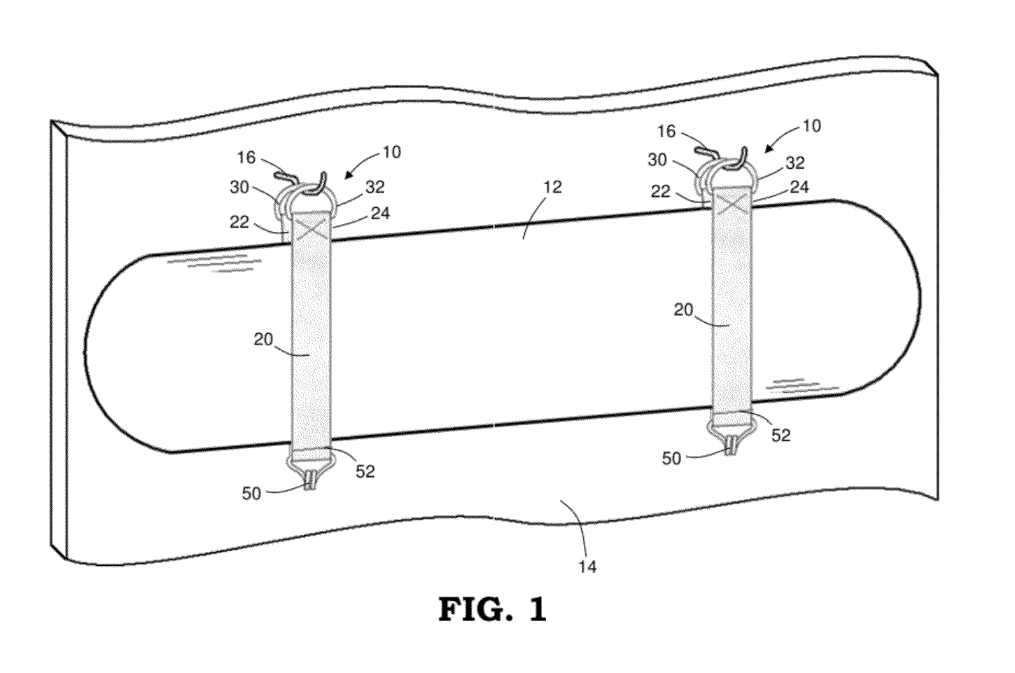

Referring now to the drawings, there is illustrated in FIG. 1 a pair of support straps, indicated generally at 10, in accordance with this invention. As shown, the support straps 10 are adapted to suspend a sports board 12 in a generally horizontal position from a support structure 14 for displaying the sports board 12. The support straps 10 will be described in further detail below.

The illustrated sports board 12 is an elongated piece of equipment that is intended for use during a sport or recreational activity. For example, the sports board 12 can be a snowboard, a surfboard, a skateboard, or the like. The support straps 10 may also be adapted to support a plurality of sports boards 12 in a back-to-back or stacked configuration, such as a pair of snow skis, water skis, snow shoes, or the like. The sports board 12 may also be embodied as a baseball bat, a golf club, various types or rackets, or any other type of sporting good equipment. The sports board 12 preferably includes various color combinations, graphic designs, artwork, and other types of aesthetic features such that a person might desire to display the sports board 12, although such is not required.

The support structure 14 can be any structure that is adapted to support the sports board 12 therefrom, such as a vertically extending wall for example. Alternatively, the support structure 14 can be a ceiling, door jams, wall studs, posts, rafters, a display rack, or the like. As shown in FIG. 1, a pair of mounting members 16 is secured to the support structure 14. The illustrated mounting members 16 are J-hooks that can be screwed into the support structure 14 so as to extend outwardly from a vertical surface thereof. Alternatively, the mounting members 16 may be pegs, brackets, nails, or the like. The mounting members 16 can be secured to the support structure 14 in any manner or may otherwise be integrally formed with the support structure 14. As will be explained below, the support straps 10 are removably supported on the support structure 14 by the mounting members 16. Thus, any number of mounting members 16 may be used that corresponds with a desired number of support straps 10.

The illustrated mounting members 16 are spaced apart from one another such that the support straps 10 will be positioned near opposite end portions of the sports board 12. It should be appreciated, however, that the mounting members 16 can be spaced any distance apart in order to position the support straps 10 along any portion of the sports board 12. Further, any number of support straps 10 can be used as desired.

As shown in FIG. 1, the mounting members 16 are secured to the support structure 14 along a generally horizontal line that is located a desired height above a floor or other surface. Thus, the support straps 10 are configured to support the sports board 12 in a generally horizontal position relative to the floor. Alternatively, the mounting members 16 can be mounted at different heights from the floor along a line that defines an oblique angle relative to the floor. In this embodiment, the support straps 10 are configured to support the sports board 12 at an oblique angle relative to the floor.

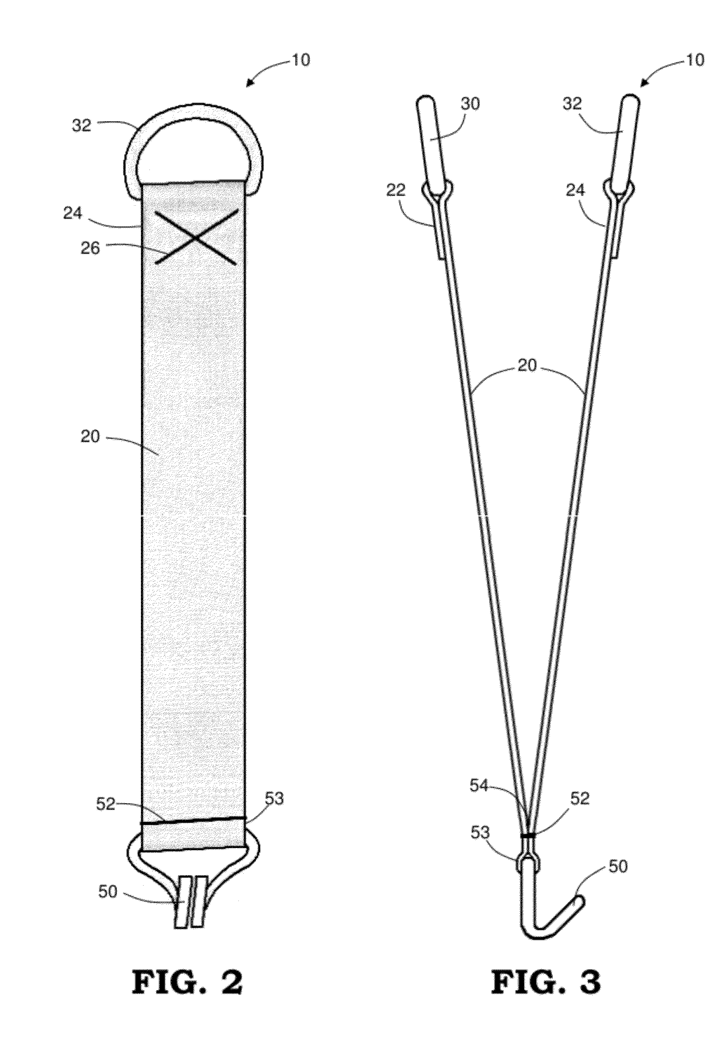

The support straps 10 will now be described in further detail. As shown in FIG. 1, the illustrated support straps 10 are preferably similar to one another. Therefore, only a single support strap 10 will be described. Referring to FIGS. 2 and 3, the illustrated support strap 10 includes a strap 20. The strap 20 is configured to be folded around a portion of the sports board 12 for supporting it relative to the support structure 14, as will be explained below. Thus, the strap 20 can be made from any generally flexible material having sufficient strength to support the applied weight of a desired sports board 12. In one non-limiting example, the strap 20 can be made from a woven nylon fabric. Alternatively, the strap 20 can be formed from leather, rope, or any other material. The illustrated strap 20 preferably has a width of approximately 2.0 inches and an overall length of approximately 30 inches. However, the strap 20 can have any dimensions for a desired application. For example, the strap 20 can have a width in the range of approximately 1.5 to 2.5 inches and a length in the range of approximately 25 to 35 inches. In other embodiments, the strap 20 can have a width in the range of approximately 1.0 to 3.0 inches and a length in the range of approximately 20 to 40 inches. It should also be appreciated that the strap 20 may be any color or combination of colors and can include decals, patches, or other indicia so as to create an aesthetically attractive support strap 10, although such is not required.

The illustrated strap 20 has a first end 22 and a second end 24. A first member 30 is attached to the first end 22 and a second member 32 is attached to the second end 24. The first and second members 30, 32 are configured to removably connect the respective first and second ends 22, 24 of the strap 20 to the mounting members 16, as will be explained below. In the illustrated embodiment, the first and second members 30, 32 are D-shaped rings, although the rings can have any desired shape, such as circular rings, oval rings, and triangular rings. Alternatively, the first and second members 30, 32 may be hooks, clips, clasps, buckles, or any other removable fasteners that are configured to be secured to the mounting members 16. The illustrated first and second members 30, 32 can be made from any suitably rigid material, such as a metal or a plastic for example, and may be any desired color or combination of colors. A protective coating or the like can be provided on the first and second members 30, 32, although such is not required. The protective coating may also be any desired color or combination of colors. It should also be appreciated that the first and second ends 22, 24 of the strap 20 may alternatively have loops or eyelets formed therein such that the first and second members 30, 32 are not necessary.

As shown, the first and second ends 22, 24 of the strap 20 form looped ends for connecting the first and second members 30, 32 thereto. To accomplish this, the first and second ends 22, 24 of the strap 20 are separately fed through the respective first and second members 30, 32 and overlapped along an intermediate length of the strap 20. The overlapped portions of the strap 20 are then secured together, such as with a threaded stitching 26 or the like. The threaded stitching 26 can have any pattern, design configuration, or other aesthetic feature as desired. Alternatively, the overlapped portions of the strap 20 can be secured together using an adhesive, an interweaving process, a fused portion, snaps, rivets, knots, or any other fastening means. It should also be appreciated that the first and second members 30, 32 can be attached to the first and second ends 22, 24 of the strap 20 using fasteners or any other configuration.

The illustrated support strap 10 also includes a third member 50, although such is not required. The third member 50 is provided along an intermediate length of the strap 20, which is located between the first and second ends 22, 24 thereof. The third member 50 can be configured to suspend or otherwise support additional objects, such as coats, boots, gloves, protective gear, additional support straps, and any other equipment from the support strap 10 if so desired. For example, the illustrated third member 50 is a slip hook having a hook portion that generally extends outwardly from a front of the support strap 10 (i.e. away from the support structure 14). The third member 50 may, alternatively, be any other support member that is adapted to removably secure additional objects on the support strap 10, such as an annular ring, a clip, or the like. The illustrated third member 50 can be made from any suitably rigid material such as a metal or plastic for example, and may be any color or combination of colors. A protective coating or the like can be provided on the third member 50, although such is not required. The protective coating may also be any desired color or combination of colors.

The third member 50 can be carried on the strap 20 in any manner. In the illustrated embodiment, an intermediate portion of the strap 20 is passed through an aperture that is formed in the third member 50. A portion of the strap 20 is overlapped on itself and secured together by a threaded stitching 52, for example, to form a closed loop 53. The third member 50 is thus secured within the closed loop 53. The closed loop 53 prevents an edge of the sports board 12 from contacting the third member 50, which may otherwise damage the sports board 12. As further shown in FIG. 3, inner surfaces of the strap 20 are secured in contact with one another to form a crease 54 that is configured to receive an edge of the sports board 12. The illustrated crease 54 preferably forms a V-shaped configuration when viewed from the side, but may have any other desired configuration. The crease 54 provides added support and stability to the sports board 12 when it is suspended by the support strap 10, as will be explained below.

The threaded stitching 52 can have any pattern, design configuration, or other aesthetic feature as desired. Alternatively, the overlapped portion of the strap 20 can be secured together using an adhesive, an interweaving process, a knot, a fused portion, snaps, rivets, or any other fastening means. As such, the illustrated third member 50 is secured along a portion of the strap 20, such as near a bottom portion thereof when the support strap 10 is folded around sports board 12 (see. FIG. 1). It should be appreciated, however, that the third member 50 can be secured along any portion of the strap 20. Further, the support strap 10 may include any number of third members 50 as desired.

Referring back to FIG. 1, a method for removably supporting the sports board 12 relative to the support structure 14 will be explained. The pair of mounting members 16 can be mounted to the support structure 14 as described above. The first members 30 can be attached to the respective mounting members 16. For example, respective ends of the mounting members 16 can be received within the apertures that are formed by the first members 30. As such, the first ends 22 of the pair of straps 20 are secured to the respective mounting members 16 such that the second ends 24 hang freely.

A first end of the sports board 12 can be positioned below one of the mounting members 16 so that is extends over the support strap 10. The second end 24 of the respective support strap 10 that is hanging freely can be folded upwardly around a front side of the sports board 12 and secured to the mounting member 16 using the second member 32. The second member 32 can be secured to the mounting member 16 as described above with the first member 30. A second or opposite end of the sports board 12 can be similarly positioned below the other mounting member 16. The second end 24 of the respective support strap 10 that is hanging freely can be folded upwardly around the front side of the sports board 12 and secured to the respective mounting member 16 using the second member 32, as described above.

In this configuration, each strap 20 extends downwardly along a rear surface of the sports board 12, around a bottom edge thereof, and upwardly along the front surface of the sports board 12. As shown, a lower edge of the sports board 12 is positioned within the crease 54 that is formed by the threaded stitching 52, thereby providing added support and stability to the sports board 12. A protective liner or the like may be provided along the inner surface of the strap 20 within the crease 54 in order to protect the strap 20 from sharp edges of the sports board 12, although such is not required. The respective third members 50 on the pair of support straps 10 are positioned near the bottom portion of the folded straps 20, as described above.

It should be appreciated that any other methods or steps may be used to suspend the sports board 12 from the support structure 14 using the support straps 10. For example, the support straps 10 can be first wrapped around the sports board 12 near the ends thereof. A person can simultaneously grab the first and second members 30, 32 of both support straps 10 to pick up the sports board 12. The first and second members 30, 32 of both support straps 10 can then be attached to the respective mounting members 16, as described above.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A support strap for suspending a sports board from a support structure, the support strap comprising:
a strap having a first end and a second end so as to form a non-continuous loop that is configured to extend around a portion of a sports board;
a first member provided on the first end of the strap for removably connecting the first end of the strap to a support structure;
a second member provided on the second end of the strap for removably connecting the second end of the strap to the support structure; and
a third member carried between the first and second ends of the strap for suspending a separate article from the strap, wherein a portion of the strap is positioned between the sports board and the third member such that the sports board does not contact the third member when the sports board is suspended by the support strap.

2. The support strap of claim 1, wherein the strap is made from one of woven nylon, rope, and leather material.

3. The support strap of claim 1, wherein the strap has a width in the range of approximately 1.5 to 2.5 inches and a length in the range of approximately 25 to 35 inches.

4. The support strap of claim 1, wherein the strap has a width in the range of approximately 1.0 to 3.0 inches and a length in the range of approximately 20 to 40 inches.

5. The support strap of claim 1, wherein the strap includes one of a decal, a patch, and indicia provided thereon.

6. The support strap of claim 1, wherein the first member and the second member are rings having apertures that extend therethrough.

7. The support strap of claim 6, wherein the first and second members are one of circular rings, oval rings, D-shaped rings, and triangular rings.

8. The support strap of claim 1, wherein the first and second ends of the strap form looped ends that attach the first and second members to the strap.

9. The support strap of claim 8, wherein each of the looped ends is formed by an overlapped portion of the strap that is secured together.

10. The support strap of claim 1, wherein the third member is a slip hook and the strap extends through an aperture that is defined by the slip hook.

11. The support strap of claim 1, wherein the third member is secured within a closed loop that formed by a portion of strap.

12. The support strap of claim 11, wherein the closed loop is formed by an overlapped portion of the strap that is secured together.

13. The support strap of claim 1, wherein portions of the strap are secured together along an intermediate length thereof to form a crease that is configured to receive an edge of the sports board.

14. A support strap for suspending a sports board from a support structure in a generally horizontal position, the support strap comprising:
a strap having a first end and a second end that forms a non-continuous loop for extending around a portion of a sports board, wherein portions of the strap are overlapped and secured together along an intermediate length thereof to form a crease for receiving an edge of the sports board;
a first member provided on the first end of the strap for removably connecting the first end of the strap to a support structure;
a second member provided on the second end of the strap for removably connecting the second end of the strap to the support structure; and
a third member carried between the first and second ends of the strap for suspending a separate article from the strap, wherein the third member is secured within a closed loop that is formed by a portion of the strap such that the sports board does not contact the third member when the sports board is suspended by the support strap.

15. The support strap of claim 14, wherein the first and second members are one of circular rings, oval rings, D-shaped rings, and triangular rings.

16. The support strap of claim 14, wherein the first and second ends of the strap form looped ends that attach the first and second members to the strap.

17. The support strap of claim 16, wherein each of the looped ends is formed by an overlapped portion of the strap that is secured together.

18. The support strap of claim 14, wherein the closed loop is formed by the overlapped portions of the strap that are secured together to form the crease.

19. A method for suspending a sports board from a support structure in a generally horizontal position comprising the steps of:
connecting a first end of a first support strap to a first mounting member that is provided on a support structure;
connecting a first end of a second support strap to a second mounting member that is provided on the support structure and spaced apart from the first mounting member;
positioning a sports board adjacent to the support structure so that opposite ends of the sports board overlap the first and second support straps;
looping the first support strap around the sports board and connecting a second end of the first support strap to the first mounting member; and
looping the second support strap around the sports board and connecting a second end of the second support strap to the second mounting member.

20. The method of claim 19 further including the step of suspending a separate article from a member that is provided on at least one of the first and second support straps.
